(19) United States
(12) Patent Application Publication
(10) Pub. No.: US 2018/0131889 A1
(43) Pub. Date: May 10, 2018

(54) NON-TRANSITORY COMPUTER-READABLE STORAGE MEDIUM, CONTROL METHOD, AND CONTROL DEVICE

(71) Applicant: FUJITSU LIMITED, Kawasaki-shi (JP)

(72) Inventor: Taishi Someya, Kawasaki (JP)

(73) Assignee: FUJITSU LIMITED, Kawasaki-shi (JP)

(21) Appl. No.: 15/805,588

(22) Filed: Nov. 7, 2017

(30) Foreign Application Priority Data
Nov. 10, 2016 (JP) 2016-219626

(51) Int. Cl. H04N 5/38; G06K 9/00; G06F 3/14; H04N 5/265

(52) U.S. Cl. CPC H04N 5/38; G06K 9/00624; G06F 1/163; H04N 5/265; G06F 3/1454

(57) ABSTRACT

A non-transitory computer-readable storage medium storing a program that causes a computer to perform a process, the process including obtaining a captured image captured by a camera, determining whether a reference object is included in the obtained captured image, transmitting the captured image to a terminal device when the reference object is included in the obtained captured image, restricting a transmission of the captured image to the terminal device when the reference object is not included in the obtained captured image, and outputting, on a screen, data received from the terminal device in response to the transmitting the captured image.

### CROSS-REFERENCE TO RELATED APPLICATION

This application is based upon and claims the benefit of priority of the prior Japanese Patent Application No. 2016-219626, filed on Nov. 10, 2016, the entire contents of which are incorporated herein by reference.

### FIELD

The embodiments discussed herein are related to a non-transitory computer-readable storage medium, a control method, and a control device.

### BACKGROUND

In recent years, augmented reality (AR) techniques that display an object in a superimposed manner on a captured image using a display device, such as a head mount display (hereinafter also referred to as a head mounted display (HMD)), or the like have been proposed. The captured image is, for example, an image captured by an imaging device disposed on an HMD and transmitted to a terminal device coupled to the HMD. In the terminal device, for example, whether or not there is an AR marker on the captured images that are consecutively obtained is recognized by image processing. The terminal device generates a superimposed image produced by superimposing an object, for example, an AR content, or the like on a captured image based on the result of image processing and transmits the superimposed image to the HMD to display.

A related-art technique is disclosed in Japanese Laid-open Patent Publication No. 2016-082528.

### SUMMARY

According to an aspect of the invention, a non-transitory computer-readable storage medium storing a program that causes a computer to perform a process, the process including obtaining a captured image captured by a camera, determining whether a reference object is included in the obtained captured image, transmitting the captured image to a terminal device when the reference object is included in the obtained captured image, restricting a transmission of the captured image to the terminal device when the reference object is not included in the obtained captured image, and outputting, on a screen, data received from the terminal device in response to the transmitting the captured image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a control system according to a first embodiment;

FIG. 2 is a diagram illustrating an example of the hardware configuration of an HMD;

FIG. 3 is a diagram illustrating an example of an object data storage unit;

FIG. 4 is a sequence chart illustrating an example of control processing according to the first embodiment;

FIG. 5 is a block diagram illustrating an example of the configuration of a control system according to a second embodiment; and

FIGS. 6A and 6B are a sequence chart illustrating an example of control processing according to the second embodiment.

### DESCRIPTION OF EMBODIMENTS

However, there are cases where captured images obtained by an HMD do not have to be viewed, for example, during movement from a certain work place to another work place, during work at a place where there are no AR markers, or the like. In these cases, it is unlikely that an AR marker is included in the captured images, and thus it is thought that the captured images do not have to be transmitted from the HMD to the terminal device. In related art such as described in the background of this application, a captured image not including an AR marker is transmitted from the HMD to the terminal device in the same manner as a captured image including an AR marker, and thus extra power regarding image processing is sometimes consumed.

According to an aspect of the present disclosure, it is desirable to provide a control program, a control method, and a control device that are capable of reducing the power consumption demanded for transmitting images to a terminal device.

In the following, detailed descriptions will be given of a control program, a control method, and a control device according to embodiments of the present disclosure with reference to the drawings. In this regard, the disclosed techniques are not limited to the embodiments. Also, the following embodiments may be suitably combined within a range in which inconsistency does not arise.

### First Embodiment

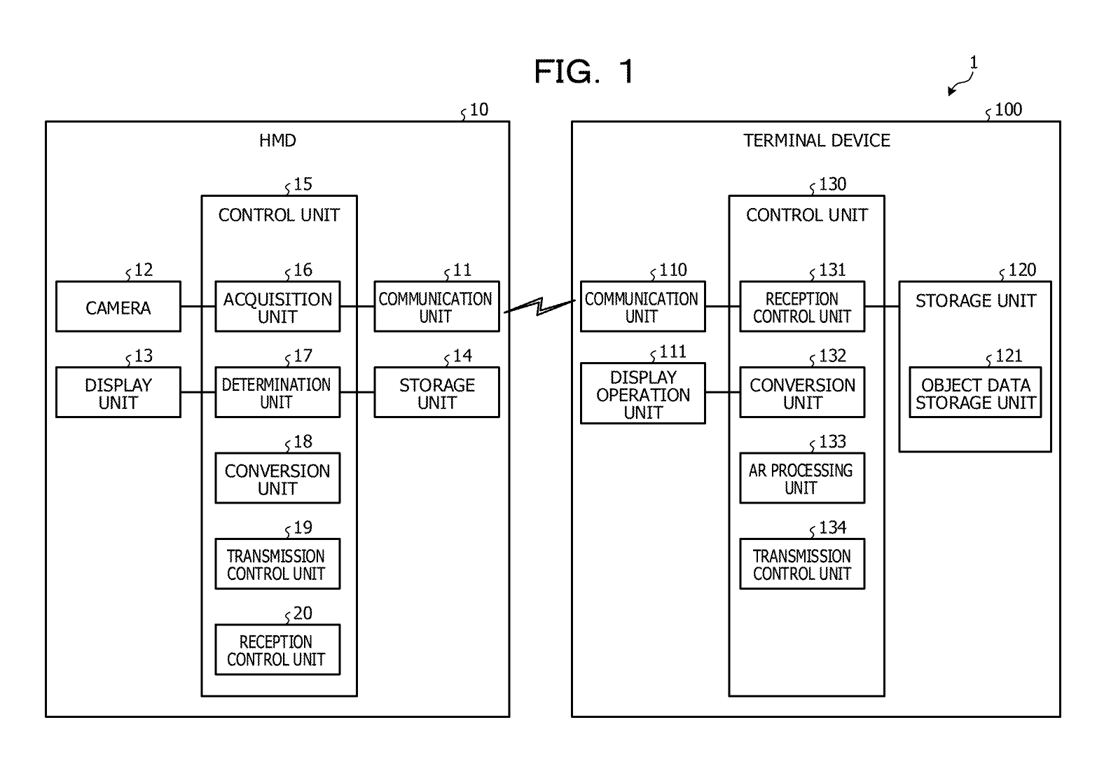

FIG. 1 is a block diagram illustrating an example of a control system according to a first embodiment. A control system 1 illustrated in FIG. 1 includes an HMD 10 and a terminal device 100. The HMD 10 and the terminal device 100 are, for example, coupled wirelessly on a one-to-one basis. That is to say, the HMD 10 functions as an example of the display unit of the terminal device 100. In this regard, in FIG. 1, for a set of the HMD 10 and the terminal device 100, one set is illustrated as an example. However, the number of sets of the HMD 10 and the terminal device 100 is not limited, and any number of sets of the HMD 10 and the terminal device 100 may be included.

The HMD 10 and the terminal device 100 are mutually coupled in a communicable way by a wireless local area network (LAN), for example, Wi-Fi Direct (registered trademark), or the like. In this regard, the HMD 10 and the terminal device 100 may be wiredly coupled.

The HMD 10 is worn by a user with the terminal device 100 and displays a display screen transmitted from the terminal device 100. For the HMD 10, it is possible to use a monocular transmissive type HMD, for example. In this regard, various HMDs, for example, a binocular type, an immersive type, or the like may be used for the HMD 10. Also, the HMD 10 includes a camera, which is an example of an imaging device.

The HMD 10 obtains a captured image captured by the imaging device. The HMD 10 determines whether or not the obtained captured image includes a reference object. If the obtained captured image includes a reference object, the HMD 10 transmits the captured image to the terminal device 100. When the HMD 10 receives an image produced by superimposing superimposition data in accordance with a reference object on the transmitted captured image, the HMD 10 displays the received image on the display unit. Thereby, it is possible for the HMD 10 to reduce the power consumption demanded for transmitting an image to the terminal device 100.

Also, the HMD 10 obtains captured images captured by the imaging device in sequence and transmits the obtained captured images to the terminal device 100. In this case, the HMD 10 determines whether or not the obtained captured image includes a reference object. If the obtained captured image does not include a reference object, the HMD 10 prevents transmission of images to the terminal device 100. Thereby, it is possible for the HMD 10 to reduce the power consumption demanded for image transmission to the terminal device 100.

The terminal device 100 is an information processing device that is worn and operated by the user. For example, it is possible to use a mobile communication terminal, such as a tablet terminal, a smartphone, or the like for the terminal device 100. When the terminal device 100 receives image data from, for example, the HMD 10, the terminal device 100 decodes the received image data. Also, the terminal device 100 performs recognition processing of an AR marker and superimposed display processing of an AR content on the image received from the HMD 10 to generate a superimposed image. The terminal device 100 transmits the generated superimposed image to the HMD 10 and causes the HMD 10 to display the image.

Next, a description will be given of the configuration of the HMD 10. As illustrated in FIG. 1, the HMD 10 includes a communication unit 11, a camera 12, a display unit 13, a storage unit 14, and a control unit 15. In this regard, the HMD 10 may include functional units of, for example, various input devices, an audio output device, or the like in addition to the functional units illustrated in FIG. 1.

The communication unit 11 is realized by a communication module, for example, a wireless LAN, or the like. The communication unit 11 is a communication interface that is wirelessly coupled with the terminal device 100, for example, by Wi-Fi Direct (registered trademark) and controls the communication of information with the terminal device 100. The communication unit 11 transmits image data corresponding to the captured image that is input from the control unit 15 to the terminal device 100. Also, the communication unit 11 receives image data corresponding to the superimposed image from the terminal device 100. The communication unit 11 outputs the received image data to the control unit 15.

The camera 12 is an imaging device that captures the image of a predetermined shape associated with an AR content, that is to say, an AR marker. The camera 12 captures an image using, for example, a complementary metal oxide semiconductor (CMOS) image sensor, a charge coupled device (CCD) image sensor, or the like as an imaging device. The camera 12 performs photoelectric conversion on the light received by the imaging device and analog/digital (A/D) conversion to generate a captured image. The camera 12 outputs the generated captured image to the control unit 15.

The display unit 13 is a display device for displaying various kinds of information. The display unit 13 corresponds to a display element of a transmissive HMD in which, for example, an image is projected on a half mirror and that enables the user to transmissively view an external scene with the image. In this regard, the display unit 13 may be a display element that corresponds to an HMD, such as an immersive type, a video transmission type, a retinal projection type, or the like.

The storage unit 14 is realized by a storage device, such as a semiconductor device, for example, a random access memory (RAM), a flash memory, or the like. The storage unit 14 stores information used for the processing by the control unit 15.

The control unit 15 is realized by, for example, a central processing unit (CPU), a micro processing unit (MPU), or the like executing the programs stored in the internal storage device using the RAM as a work area. Also, the control unit 15 may be realized by an integrated circuit, for example, an application specific integrated circuit (ASIC), a field programmable gate array (FPGA), or the like.

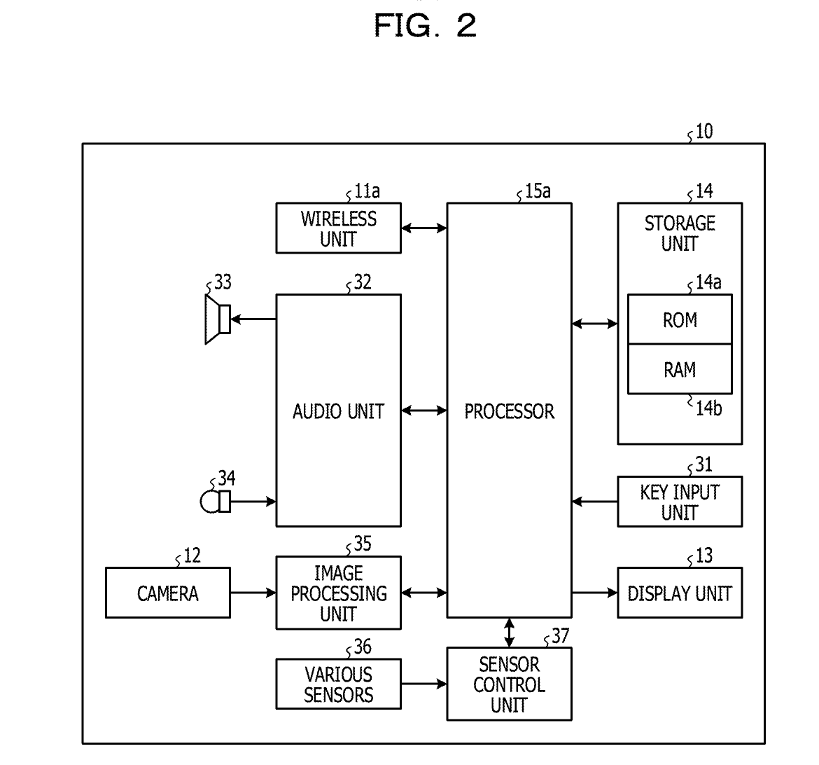

Here, a description will be given of the hardware configuration of the HMD 10 with reference to FIG. 2. FIG. 2 is a diagram illustrating an example of the hardware configuration of the HMD. As illustrated in FIG. 2, in the HMD 10, a wireless unit 11a, a display unit 13, a storage unit 14, a key input unit 31, an audio unit 32, an image processing unit 35, and a sensor control unit 37 are coupled to a processor 15a, which is an example of the control unit 15, via an unillustrated bus, for example.

The wireless unit 11a is an example of the communication unit 11. The storage unit 14 includes, for example, a read only memory (ROM) 14a and a RAM 14b. The key input unit 31 is a power button of the HMD 10, for example, but may include a button having the other functions. A speaker 33 and a microphone 34 are coupled to the audio unit 32. The audio unit 32, for example, controls sound input and output. A camera 12 is coupled to the image processing unit 35. The image processing unit 35 controls the camera 12 based on the information, such as, for example, a focus, an exposure, a gain, a brightness value (BV) and a color temperature, and the like that are input from the camera 12, and performs image processing on the captured image that is input from the camera 12. Various sensors 36, for example, an acceleration sensor, a geomagnetic sensor, or the like are coupled to the sensor control unit 37. The sensor control unit 37 controls various sensors 36.

Referring back to FIG. 1, the control unit 15 includes an acquisition unit 16, a determination unit 17, a conversion unit 18, a transmission control unit 19, and a reception control unit 20, and realizes or executes the functions or the operations of the information processing described below. In this regard, the internal configuration of the control unit 15 is not limited to the configuration illustrated in FIG. 1 and may be another configuration as long as it is a configuration for performing the information processing described below.

The acquisition unit 16 obtains captured images from the camera 12. That is to say, the acquisition unit 16 obtains the captured images captured by the imaging device in sequence. The acquisition unit 16 outputs the obtained captured images to the determination unit 17. Also, the acquisition unit 16 determines whether or not a power off signal is input from the key input unit 31, for example. That is to say, the acquisition unit 16 determines whether or not to terminate the processing. If the acquisition unit 16 does not terminate the processing, the acquisition unit 16 continues to obtain the captured images that are input from the camera 12. If the acquisition unit 16 terminates the processing, the acquisition unit 16 performs shutdown processing for each unit of the HMD 10.

When a captured image is input from the acquisition unit 16, the determination unit 17 determines whether or not the input captured image includes the shape of an AR marker. That is to say, the determination unit 17 determines whether or not the input captured image includes a reference object. Also, the shape of an AR marker is an example of a predetermined shape, and is a rectangle, for example. If the determination unit 17 determines that the captured image includes the shape of an AR marker, the determination unit 17 outputs the captured image to the conversion unit 18. If the determination unit 17 determines that the captured image does not include the shape of an AR marker, the determination unit 17 does not output the captured image to the conversion unit 18 and waits for input of the next captured image.

The conversion unit 18 is an encoder and decoder that performs encoding on the obtained captured image, and performs decoding on the received image data. When a captured image is input from the determination unit 17 to the conversion unit 18, the conversion unit 18 performs encoding on the input captured image. At this time, the conversion unit 18 performs encoding, for example, at a frame rate that matches the frame rate (transmission rate) used for transmission from the transmission control unit 19 to the terminal device 100. In this regard, the conversion unit 18 may perform encoding at a frame rate different from the frame rate of the transmission from the transmission control unit 19 to the terminal device 100. The conversion unit 18 performs encoding, for example, on a captured image having a resolution of 720×480 with a bit rate of 10 megabits per second (Mbps) and a frame rate of 30 fps (frame per second) using Main Profile (MP) of H.264, Level3. The conversion unit 18 outputs the image data obtained by performing encoding on the captured image to the transmission control unit 19.

When the received image data is input to the conversion unit 18 from the reception control unit 20, the conversion unit 18 performs decoding on the input image data and outputs the decoded image data to the display unit 13 to display the decoded image data. The received image data is decoded, for example, by H.264 used in Miracast (registered trademark).

When the transmission control unit 19 receives image data that is input from the conversion unit 18, the transmission control unit 19 transmits the input image data to the terminal device 100 via the communication unit 11. The transmission control unit 19 transmits the image data to the terminal device 100, for example, at a frame rate of 30 fps. That is to say, if the obtained captured image includes a reference object, the transmission control unit 19 transmits the captured image to the terminal device 100. Also, if the obtained captured image does not include a reference object, the transmission control unit 19 prevents transmission of the obtained captured image to the terminal device 100. Further, the transmission control unit 19 may transmits information indicating that the captured image includes a reference object to the terminal device 100 together with the image data.

The reception control unit 20 receives image data from the terminal device 100, for example, by Miracast (registered trademark) using Wi-Fi Direct (registered trademark) via the communication unit 11. The image data is image data corresponding to a superimposed image on which an AR content is superimposed. The reception control unit 20 outputs the received image data to the conversion unit 18. That is to say, the conversion unit 18 and the reception control unit 20 provide an example of a display control unit that displays the received image on the display unit 13 when the image produced by superimposing superimposition data in accordance with the reference object on the transmitted captured image is received.

Next, a description will be given of the configuration of the terminal device 100. As illustrated in FIG. 1, the terminal device 100 includes a communication unit 110, a display operation unit 111, a storage unit 120, and a control unit 130. In this regard, the terminal device 100 may include various functional units held by a known computer other than the functional units illustrated in FIG. 1, for example, various input devices, audio output devices, and the like.

The communication unit 110 is realized by a communication module, or the like, for example, a wireless LAN, or the like. The communication unit 110 is a communication interface that is wirelessly coupled to the HMD 10 by, for example, Wi-Fi Direct (registered trademark) and controls communication of information with the HMD 10. The communication unit 110 receives image data corresponding to the captured image from the HMD 10. The communication unit 110 outputs the received image data to the control unit 130. Also, the communication unit 110 transmits image data corresponding to the superimposed image input from the control unit 130 to the HMD 10.

The display operation unit 111 is a display device for displaying various kinds of information and an input device for receiving various operations from the user. For example, the display operation unit 111 is realized by a liquid crystal display, or the like as the display device. Also, for example, the display operation unit 111 is realized by a touch panel, or the like as the input device. That is to say, the display operation unit 111 is an integrated combination of the display device and the input device. The display operation unit 111 outputs the operation input by the user to the control unit 130 as operation information. In this regard, the display operation unit 111 may display the same screen as that of the HMD 10 or a screen different from that of the HMD 10.

The storage unit 120 is realized by a semiconductor memory device, for example, a RAM, a flash memory, or the like, or storage device, such as a hard disk, an optical disc, or the like. The storage unit 120 includes an object data storage unit 121. Also, the storage unit 120 stores information used by the processing by the control unit 130.

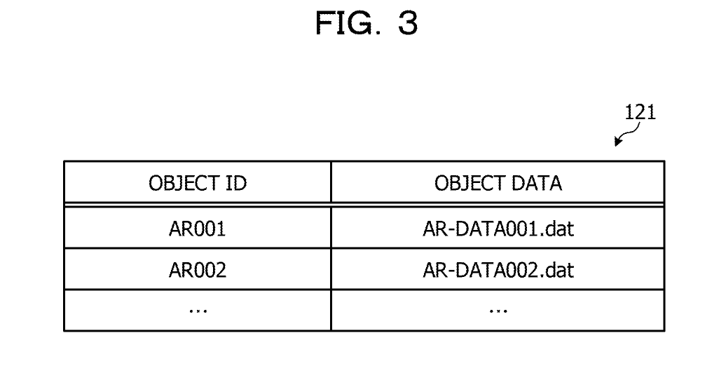

The object data storage unit 121 stores object data. FIG. 3 is a diagram illustrating an example of the object data storage unit. As illustrated in FIG. 3, the object data storage unit 121 has items of “object identifier (ID)” and “object data”. The object data storage unit 121 stores, for example, each object data as one record. In this regard, the object data storage unit 121 may store another item, for example, position information in association with object data.

The item “object ID” is an identifier that identifies object data, that is to say, an AR content. The item “object data” is information indicating object data. The item “object data” is, for example, object data, that is to say, a data file that contains an AR content.

The control unit 130 is realized by, for example, a CPU, an MPU, or the like executing a program stored in an internal storage device using a RAM as a work area. Also, the control unit 130 may be realized by an integrated circuit, for example, an ASIC, an FPGA, or the like. The control unit 130 includes a reception control unit 131, a conversion unit 132, an AR processing unit 133, a transmission control unit 134, and realizes or performs the function or the operations of the information processing described below. In this regard, the internal configuration of the control unit 130 is not limited to the configuration illustrated in FIG. 1, and may be another configuration as long as the information processing described below is performed.

When the reception control unit 131 receives, via the communication unit 110, image data from the HMD 10, that is to say, image data corresponding to the captured image, the reception control unit 131 outputs the received image data to the conversion unit 132. In this regard, when the reception control unit 131 receives information indicating that the captured image includes a reference object from the HMD 10 together with image data, the reception control unit 131 instructs the AR processing unit 133 to perform AR marker recognition processing only on the image data associated with the information.

When the conversion unit 132 receives input of the image data received from the reception control unit 131, the conversion unit 132 performs decoding on the input image data and outputs the decoded image data to the AR processing unit 133. The received image data is decoded by using, for example, H.264.

When the conversion unit 132 receives input of image data corresponding to the superimposed image from the AR processing unit 133, the conversion unit 132 performs encoding on the input image data so as to enable transmission using Miracast (registered trademark). The conversion unit 132 performs encoding, for example, using H.264. The conversion unit 132 outputs the encoded image data to the transmission control unit 134.

When the AR processing unit 133 receives input of the decoded image data from the conversion unit 132, the AR processing unit 133 performs AR marker recognition processing on the input image data. The AR processing unit 133 refers to the object data storage unit 121 and generates a superimposed image by superimposing object data corresponding to the recognized AR marker, that is to say, an AR content on the image data. That is to say, the AR processing unit 133 generates the superimposed image by superimposing superimposition data corresponding to the reference object on the input image data. The AR processing unit 133 outputs image data corresponding to the generated superimposed image to the conversion unit 132.

When the transmission control unit 134 receives input of the encoded image data from the conversion unit 132, the transmission control unit 134 transmits the input image data to the HMD 10 via the communication unit 110. That is to say, the transmission control unit 134 transmits image data corresponding to the superimposed image to the HMD 10 by, for example, Miracast (registered trademark) using Wi-Fi Direct (registered trademark).

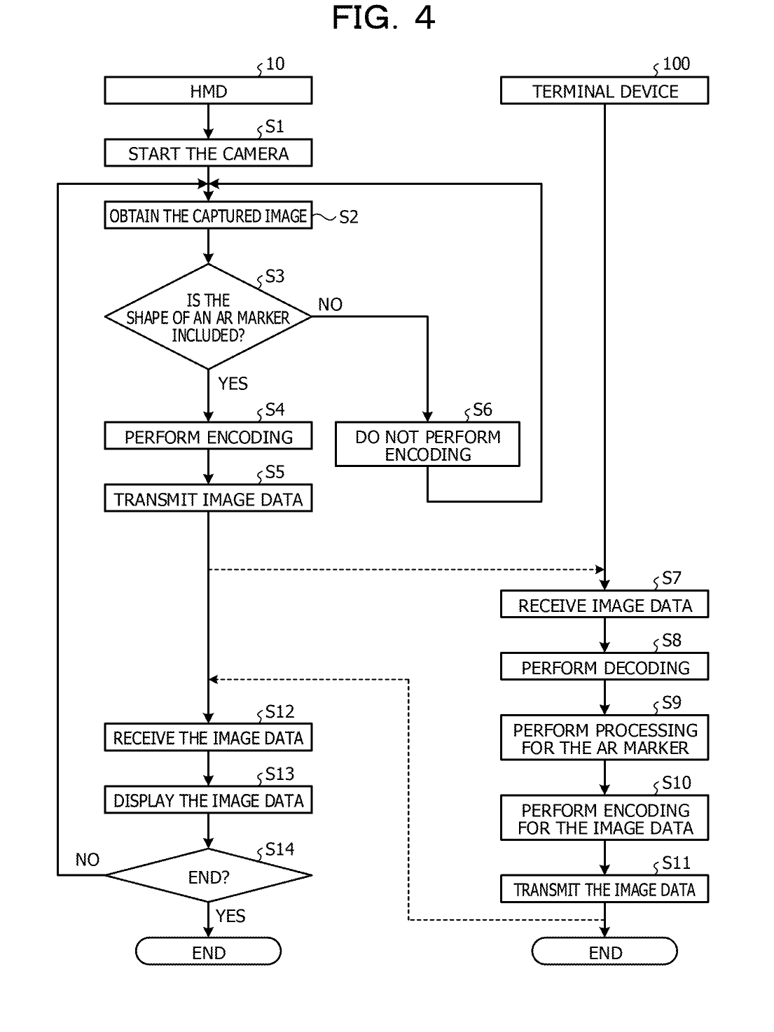

Next, a description will be given of the operation of the control system 1 according to the embodiment. FIG. 4 is a sequence chart illustrating an example of control processing according to the first embodiment.

For example, when a user turns on the power to the HMD 10 in the control system 1, the HMD 10 starts the camera 12 (step S1). When the camera 12 is started, the camera starts outputting a captured image to the control unit 15. The acquisition unit 16 of the HMD 10 starts obtaining the input captured image from the camera 12 (step S2). The acquisition unit 16 outputs the obtained captured image to the determination unit 17.

When the determination unit 17 receives input of the captured image from the acquisition unit 16, the determination unit 17 determines whether or not the input captured image includes the shape of an AR marker (step S3). If the determination unit 17 determines that the captured image includes the shape of an AR marker (step S3: affirmation), the determination unit 17 outputs the captured image to the conversion unit 18.

When the conversion unit 18 receives input of the captured image from the determination unit 17, the conversion unit 18 performs encoding on the input captured image (step S4). The conversion unit 18 outputs image data obtained by having performed encoding on the captured image to the transmission control unit 19. When the transmission control unit 19 receives input of image data from the conversion unit 18, the transmission control unit 19 transmits the input image data to the terminal device 100 (step S5).

If the determination unit 17 determines that the captured image does not include the shape of an AR marker (step S3: negation), the determination unit 17 does not output the captured image to the conversion unit 18, that is to say, does not perform encoding (step S6), and the processing returns to step S2.

When the reception control unit 131 of the terminal device 100 receives image data from the HMD 10 (step S7), the reception control unit 131 outputs the received image data to the conversion unit 132.

When the conversion unit 132 receives input of the image data received from the reception control unit 131, the conversion unit 132 performs decoding on the input image data (step S8) and outputs the decoded image data to the AR processing unit 133.

When the AR processing unit 133 receives input of the decoded image data from the conversion unit 132, the AR processing unit 133 performs processing for an AR marker on the input image data (step S9). That is to say, the AR processing unit 133 refers to the object data storage unit 121 and generates a superimposed image by superimposing an AR content on the image data. The AR processing unit 133 outputs image data corresponding to the generated superimposed image to the conversion unit 132.

When the conversion unit 132 receives image data corresponding to the superimposed image from the AR processing unit 133, the conversion unit 132 performs encoding on the input image data (step S10). The conversion unit 132 outputs the encoded image data to the transmission control unit 134.

When the transmission control unit 134 receives the encoded image data from the conversion unit 132, the transmission control unit 134 transmits the input image data to the HMD 10 (step S11).

The reception control unit 20 of the HMD 10 receives the image data from the terminal device 100 (step S12). The reception control unit 20 outputs the received image data to the conversion unit 18.

When the conversion unit 18 receives input of the received image data from the reception control unit 20, the conversion unit 18 performs decoding on the input image data and outputs the decoded image data to the display unit 13 to display (step S13).

The acquisition unit 16 determines whether or not to terminate the processing (step S14). If the acquisition unit 16 does not terminate the processing (step S14: negation), the processing returns to step S2. If the acquisition unit 16 terminates the processing (step S14: affirmation), the acquisition unit 16 performs shutdown processing for each unit of the HMD 10 and terminates the control processing. Thereby, it is possible for the HMD 10 to reduce the power consumption demanded for image transmission to the terminal device 100.

In this manner, the HMD 10 obtains a captured image captured by the camera 12, which is an imaging device. Also, the HMD 10 determines whether or not the obtained captured image includes a reference object. Also, if the obtained captured image includes a reference object, the HMD 10 transmits the captured image to the terminal device 100. Also, if the HMD 10 receives an image produced by superimposing superimposition data in accordance with a reference object on the transmitted captured image, the HMD 10 displays the received image on the display unit 13. As a result, it is possible to reduce the power consumption demanded for image transmission to the terminal device 100.

Also, if the obtained captured image does not include a reference object, the HMD 10 prevents transmission of the obtained captured image to the terminal device 100. As a result, it is possible to reduce the power consumption demanded for image transmission to the terminal device 100.

Also, the HMD 10 further transmits information indicating that the captured image includes a reference object to the terminal device 100. As a result, in the terminal device 100, it is possible to omit the recognition processing on the captured image that does not include an AR marker.

Also, the HMD 10 determines whether or not the obtained captured image includes a predetermined shape so as to determine whether or not the obtained captured image includes a reference object. As a result, it is possible to reduce the load of the recognition processing on the reference object.

### Second Embodiment

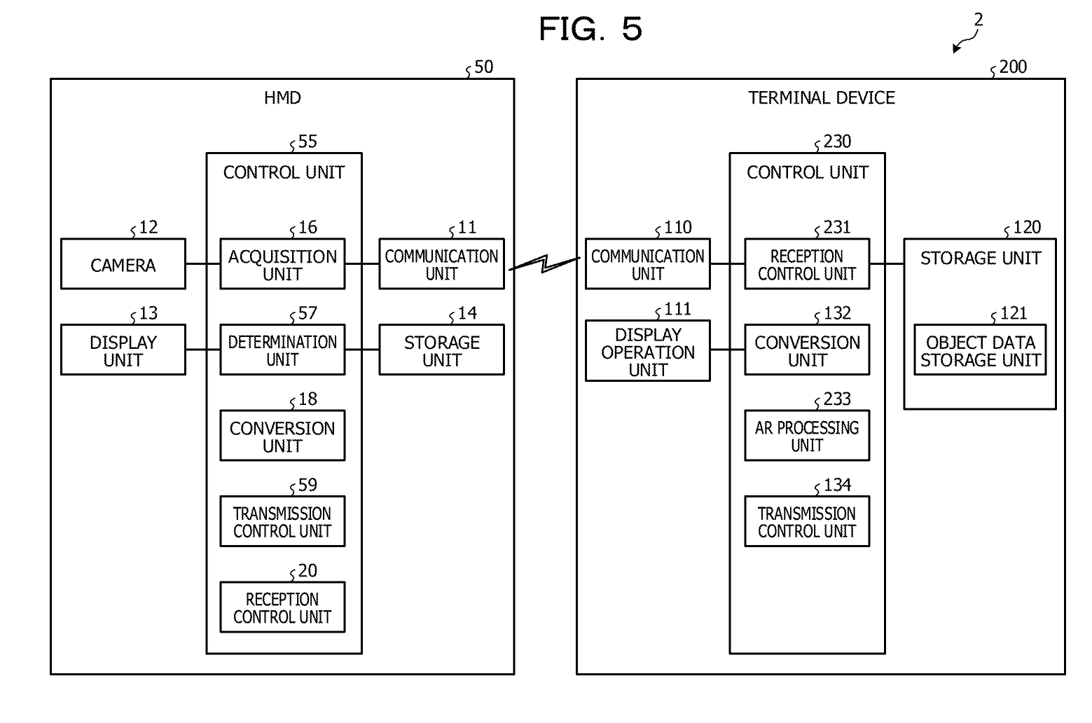

In the first embodiment described above, if a captured image does not include a reference object, transmission of the captured image to the terminal device 100 is prevented. However, the transmission frequency of the captured images may be lowered. A description will be given of an embodiment in this case as a second embodiment. FIG. 5 is a block diagram illustrating an example of the configuration of a control system according to the second embodiment. A control system 2 illustrated in FIG. 5 includes an HMD 50 and a terminal device 200. In this regard, the same reference sign is given to the same component as that in the control system 1 according to the first embodiment, and descriptions will be omitted of the duplicated configuration and operations.

Compared with the HMD 10 in the first embodiment, the HMD 50 in the second embodiment includes a control unit 55 in place of the control unit 15. Also, compared with the control unit 15 in the first embodiment, the control unit 55 includes a determination unit 57 and a transmission control unit 59 in place of the determination unit 17 and the transmission control unit 19, respectively.

When the determination unit 57 receives input of a captured image from the acquisition unit 16, the determination unit 57 determines whether or not a predetermined time period has elapsed from the transmission of the previous image data. Here, it is possible to set the predetermined time period to 10 seconds, for example. If the determination unit 57 determines that a predetermined time period has elapsed from the transmission of the previous image data, the determination unit 57 outputs the input captured image to the conversion unit 18. In this case, the determination unit 57 does not generates AR marker detection information, that is to say, the determination unit 57 does not associate AR marker detection information with the captured image and outputs the captured image to the conversion unit 18.

If the determination unit 57 determines that a predetermined time period has not elapsed from the transmission of the previous image data, the determination unit 57 determines whether or not the input captured image includes the shape of an AR marker. That is to say, the determination unit 57 determines whether or not the input captured image includes a reference object. Also, the shape of an AR marker is an example of a predetermined shape and is a rectangle, for example. If the determination unit 57 determines that the captured image includes the shape of an AR marker, the determination unit 57 generates AR marker detection information as information indicating that the captured image includes a reference object and outputs the generated AR marker detection information to the conversion unit 18 with the captured image in association with the captured image. If the determination unit 57 determines that the captured image does not include the shape of an AR marker, the determination unit 57 does not output the captured image to the conversion unit 18 and waits for input of the next captured image.

When the transmission control unit 59 receives input of the image data associated with the AR marker detection information from the conversion unit 18, the transmission control unit 59 transmits the input image data to the terminal device 200 via the communication unit 11. At this time, the transmission control unit 59 associates the AR marker detection information with the image data and transmits the image data to the terminal device 200 via the communication unit 11. Also, the transmission control unit 59 transmits the image data to the terminal device 200 at a frame rate of 30 fps, for example.

When the transmission control unit 59 receives input of the image data not associated with the AR marker detection information from the conversion unit 18, the transmission control unit 59 transmits the input image data to the terminal device 200 via the communication unit 11. At this time, the transmission control unit 59 transmits the input image data to the terminal device 200 via the communication unit 11, for example, at intervals of the predetermined time period that is used for determining whether or not the predetermined time period has elapsed from the transmission of the previous image data by the determination unit 57. That is to say, if the obtained captured image does not include a reference object, the transmission control unit 59 restricts image transmission to the terminal device 200. In other words, if the obtained captured image does not include a reference object, the transmission control unit 59 lowers the image transmission frequency to the terminal device 200 compared to the image transmission frequency when the captured image includes a reference object.

Compared with the terminal device 100 in the first embodiment, the terminal device 200 in the second embodiment includes a control unit 230 in place of the control unit 130. Also, compared with the control unit 130 in the first embodiment, the control unit 230 includes a reception control unit 231 and an AR processing unit 233 in place of the reception control unit 131 and the AR processing unit 133, respectively.

When the reception control unit 231 receives, via the communication unit 110, image data from the HMD 50, that is to say, image data corresponding to the captured image, the reception control unit 231 outputs the received image data to the conversion unit 132. Also, if the received image data is associated with AR marker detection information, the reception control unit 231 extracts the AR marker detection information from the received image data and outputs the AR marker detection information to the AR processing unit 233.

When the AR processing unit 233 receives input of the decoded image data from the conversion unit 132, the AR processing unit 233 determines whether or not the AR marker detection information corresponding to the image data has been input from the reception control unit 231. That is to say, the AR processing unit 233 determines whether or not the HMD 50 has detected an AR marker. If the AR processing unit 233 determines that the HMD 50 has detected an AR marker, the AR processing unit 233 performs AR marker recognition processing on the image data. The AR processing unit 233 refers to the object data storage unit 121 and superimposes object data corresponding to the recognized AR marker, that is to say, an AR content on the image data to generate a superimposed image. The AR processing unit 233 outputs image data corresponding to the generated superimposed image to the conversion unit 132.

If the HMD 50 has not detected an AR marker, the AR processing unit 233 directly outputs the input image data to the conversion unit 132. That is to say, the AR processing unit 233 outputs image data corresponding to the received image data to the conversion unit 132.

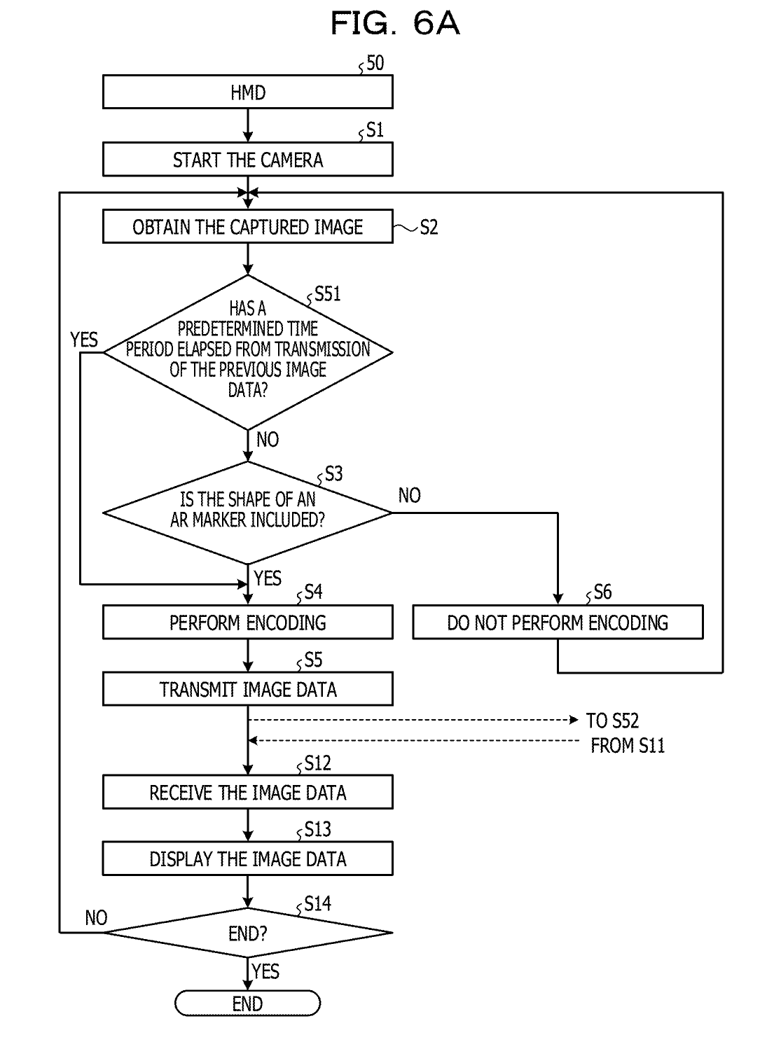

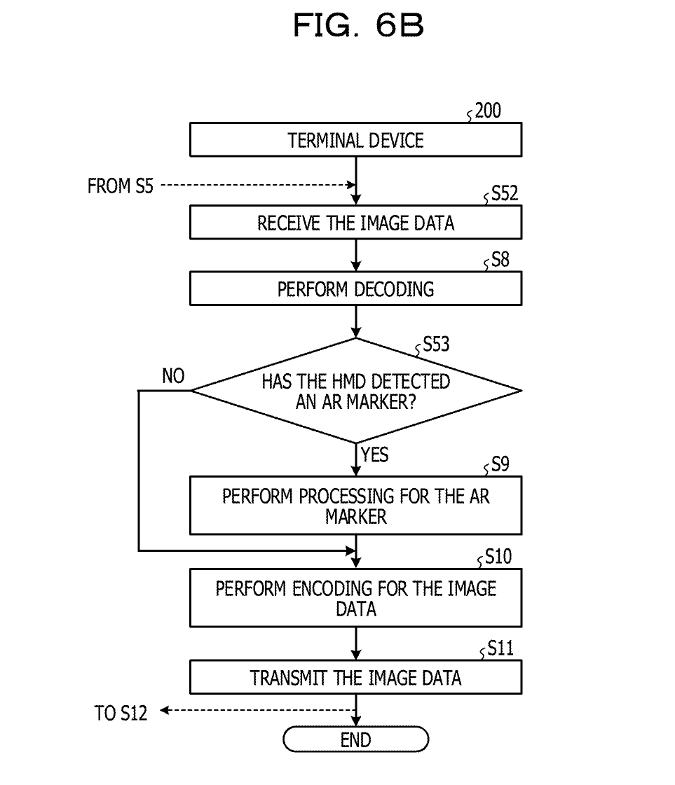

Next, a description will be given of the operation of the control system 2 according to the second embodiment. FIGS. 6A and 6B are a sequence chart illustrating an example of the control processing according to the second embodiment. In the following description, the processing in step S1, S2, S3 to S6, S8, S9 to S14 is the same as the processing in the first embodiment, and thus the description thereof will be omitted.

The HMD 50 performs the next processing subsequently to the processing in step S2. When the determination unit 57 receives input of a captured image from the acquisition unit 16, the determination unit 57 determines whether or not a predetermined time period has elapsed from the transmission of the previous image data (step S51). If the determination unit 57 determines that a predetermined time period has elapsed from the transmission of the previous image data (step S51: affirmation), the determination unit 57 outputs the input captured image to the conversion unit 18, and the processing proceeds to step S4. If the determination unit 57 determines that a predetermined time period has not elapsed from the transmission of the previous image, the processing proceeds to step S3.

The terminal device 200 performs the next processing subsequently to the processing in step S5. When the reception control unit 231 receives image data from the HMD 50 (step S52), the reception control unit 231 outputs the received image data to the conversion unit 132, and the processing proceeds to step S8. At this time, if AR marker detection information is associated with the received image data, the reception control unit 231 extracts the AR marker detection information and outputs the information to the AR processing unit 233.

The terminal device 200 performs the next processing subsequently to the processing in step S8. When the AR processing unit 233 receives input of the decoded image data from the conversion unit 132, the AR processing unit 233 determines whether or not the HMD 50 has detected an AR marker (step S53). If the AR processing unit 233 determines that the HMD 50 has detected an AR marker (step S53: affirmation), the processing proceeds to step S9. If the AR processing unit 233 determines that the HMD 50 has not detected an AR marker (step S53: negation), the AR processing unit 233 outputs image data corresponding to the received image data to the conversion unit 132, and the processing proceeds to step S10. Thereby, it is possible for the HMD 50 to reduce the power consumption demanded for image transmission to the terminal device 200.

In this manner, the HMD 50 obtains captured images captured by the camera 12, which is the imaging device, in sequence, and transmits the obtained captured images to the terminal device 200. In this case, the HMD 50 determines whether or not the obtained captured image includes a reference object. Also, if the obtained captured image does not include a reference object, the HMD 50 restricts image transmission to the terminal device 200. As a result, it is possible to reduce the power consumption demanded for image transmission to the terminal device 200.

Also, if the obtained captured image does not include a reference object, the HMD 50 lowers the frequency of image transmission to the terminal device 200 to a value lower than the frequency of image transmission in the case where the obtained captured includes a reference object. As a result, it is possible to reduce the power consumption demanded for image transmission to the terminal device 200.

Also, the HMD 50 determines whether or not the obtained captured image includes a predetermined shape so as to determine whether or not the obtained captured image includes a reference object. As a result, it is possible to reduce the recognition processing load of a reference object.

In this regard, in the second embodiment described above, if the captured image does not include a reference object, that is to say, the shape of an AR marker, the transmission frequency of image data is lowered. However, the present disclosure is not limited to this. For example, if the captured image does not include a reference object, the bit rate of image data may be lowered.

Also, in the second embodiment described above, the HMD 50 transmits the AR marker detection information. However, the present disclosure is not limited to this. For example, the terminal device 200 may detect the bit rate or the frame rate of the received image data and may perform the AR marker recognition processing or generate a superimposed image in accordance with the detected bit rate or the frame rate. Thereby, even if the HMD 50 does not transmit the AR marker detection information, it is possible for the terminal device 200 to determine whether or not to perform processing regarding an AR marker.

Also, in the second embodiment described above, after a predetermined time period elapsed from the transmission of the previous image data, the HMD 50 transmits image data regardless of whether or not the captured image includes a reference object, that is to say, the shape of an AR marker. However, the present disclosure is not limited to this. For example, the HMD 50 may transmit image data regardless of whether or not the captured image includes a reference object (the shape of an AR marker) in the case where a user of the HMD 50 has moved for a predetermined distance in place of after the elapse of a predetermined time period. In this regard, it is possible to use a value of 5 m for a predetermined distance, for example.

Also, each configuration element of each unit illustrated in FIG. 1 or FIG. 5 does not have to be physically configured as illustrated in FIG. 1 or FIG. 5. That is to say, a specific form of distribution and integration of each unit is not limited to that illustrated in FIG. 1 or FIG. 5. It is possible to configure all of or a part of them by functionally or physically distributing of integrating them in any units in accordance with various loads, a use state, or the like. For example, the conversion unit 18, the transmission control unit 19, and the reception control unit 20 may be integrated. Also, each processing illustrated in FIG. 4 or FIGS. 6A and 6B are not limited to the order described above. Each processing may be performed at the same time, or the order of the processing may be replaced within a range in which the processing contents do not conflict.

Further, all of or any part of the various processing functions performed by each device may be carried out by a CPU (or a microcomputer, such as an MPU, a microcontroller unit (MCU), or the like). Also, it goes without saying that all of or any part of the various processing functions may be performed by programs that are analyzed and executed by a CPU (or a microcomputer, such as an MPU, an MCU, or the like), or by wired logic hardware.

In this regard, it is possible for the HMD 10 or the HMD 50 described in the above embodiments to perform the same functions as those of the processing described in FIG. 1, FIG. 5, or the like by reading and executing a control program. For example, it is possible for the HMD 10 to perform the same processing as that of the first embodiment described above by executing the processes that perform the same processing as those of the acquisition unit 16, the determination unit 17, the conversion unit 18, the transmission control unit 19, and the reception control unit 20. Also, for example, it is possible for the HMD 50 to perform the same processing as that of the second embodiment described above by executing the processes that perform the same processing as those of the acquisition unit 16, the determination unit 57, the conversion unit 18, the transmission control unit 59, and the reception control unit 20.

Also, some of the functions described as being performed by the terminal device 100 or the terminal device 200 could also be performed by the HMD 10 or the HMD 50. For example, the terminal device 100 is described above to superimpose data on an image and provide the superimposed image to the HMD 10. Alternatively, the terminal device 100 could provide superimposition data to the HMD 10, and the HMD 10 could perform the superimposition to superimpose the superimposition data on an image.

It is possible to distribute these programs via a network, such as the Internet, or the like. Also, it is possible to record these programs in a computer readable recording medium, such as a hard disk, a flexible disk (FD), a CD-ROM, an MO, a DVD, or the like, and it is possible for a computer to read these programs from the recording medium and execute these programs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a computer to perform a process, the process comprising:
obtaining a captured image captured by a camera;
determining whether a reference object is included in the obtained captured image;
transmitting the captured image to a terminal device when the reference object is included in the obtained captured image;
restricting a transmission of the captured image to the terminal device when the reference object is not included in the obtained captured image; and
outputting, on a screen, data received from the terminal device in response to the transmitting the captured image.

2. The non-transitory computer-readable storage medium according to claim 1, wherein
the restricting includes preventing the transmission of the captured image to the terminal device.

3. The non-transitory computer-readable storage medium according to claim 2, wherein
the preventing is performed when a predetermined period has not elapsed from a transmission of a previous captured image obtained earlier than the captured image.

4. The non-transitory computer-readable storage medium according to claim 1, wherein
the restricting includes transmitting the captured image with a lower bit rate than the transmitting when the reference object is included in the obtained captured image.

5. The non-transitory computer-readable storage medium according to claim 1, wherein
the obtaining obtains a plurality images captured over a period of time;
the transmitting transmits at least one of the plurality of obtained images; and
the restricting decreases a frequency of the transmitting of the at least one of the plurality of obtained images when an image of the plurality of obtained images does not include the reference object.

6. The non-transitory computer-readable storage medium according to claim 1, wherein
the data received from the terminal device is an image superimposed with superimposition data corresponding to the reference object; and
the outputting outputs the image superimposed with superimposition data.

7. The non-transitory computer-readable storage medium according to claim 1, wherein
the data received from the terminal device is a superimposition data corresponding to the reference object; and
wherein the process further comprises:
superimposing the superimposition data on an image on the screen; and
the outputting outputs the image on the screen with the superimposition data superimposed.

8. The non-transitory computer-readable storage medium according to claim 1, wherein
the computer is a head mounted display that includes the camera and the screen.

9. A control method executed by a computer, the control method comprising:
obtaining a captured image captured by a camera;
determining whether a reference object is included in the obtained captured image;
transmitting the captured image to a terminal device when the reference object is included in the obtained captured image;
restricting a transmission of the captured image to the terminal device when the reference object is not included in the obtained captured image; and
outputting, on a screen, data received from the terminal device in response to the transmitting the captured image.

10. The control method according to claim 9, wherein
the restricting includes preventing the transmission of the captured image to the terminal device.

11. The control method according to claim 10, wherein
the preventing is performed when a predetermined period has not elapsed from a transmission of a previous captured image obtained earlier than the captured image.

12. The control method according to claim 9, wherein
the restricting includes transmitting the captured image with a lower bit rate than the transmitting when the reference object is included in the obtained captured image.

13. The control method according to claim 9, wherein
the obtaining obtains a plurality images captured over a period of time;
the transmitting transmits at least one of the plurality of obtained images; and
the restricting decreases a frequency of the transmitting of the at least one of the plurality of obtained images when an image of the plurality of obtained images does not include the reference object.

14. The control method according to claim 9, wherein
the data received from the terminal device is an image superimposed with superimposition data corresponding to the reference object; and
the outputting outputs the image superimposed with superimposition data.

15. A control device comprising:
a memory; and
a processor coupled to the memory and the processor configured to:
obtain a captured image captured by a camera;
determine whether a reference object is included in the obtained captured image;
transmit the captured image to a terminal device when the reference object is included in the obtained captured image;
restrict a transmission of the captured image to the terminal device when the reference object is not included in the obtained captured image; and
output, on a screen, data received from the terminal device in response to the transmitting the captured image.

16. The control device according to claim 15, wherein
the processor restricts the transmission by preventing the transmission of the captured image to the terminal device.

17. The control device according to claim 16, wherein
the processing prevents the transmission when a predetermined period has not elapsed from a transmission of a previous captured image obtained earlier than the captured image.

18. The control device according to claim 15, wherein
the processor restricts the transmission by transmitting the captured image with a lower bit rate than the transmitting when the reference object is included in the obtained captured image.

19. The control device according to claim 15, wherein
the processor obtains a plurality images captured over a period of time, transmits, transmits at least one of the plurality of obtained images, and restricts the transmission by decreasing a frequency of transmission of the at least one of the plurality of obtained images when an image of the plurality of obtained images does not include the reference object.

20. The control device according to claim 15, wherein
the data received from the terminal device is an image superimposed with superimposition data corresponding to the reference object; and
the processor outputs the image superimposed with superimposition data.
